(19) United States
(12) Patent Application Publication
(10) Pub. No.: US 2013/0148568 A1
(43) Pub. Date: Jun. 13, 2013

(54) WIRELESS COMMUNICATION DEVICE, TETHERING CONTROL METHOD AND TETHERING CONTROL PROGRAM

(71) Applicant: FUJITSU MOBILE COMMUNICATIONS LIMITED, Kawasaki-shi (JP)

(72) Inventor: Eiji IIMORI, Kawasaki (JP)

(73) Assignee: FUJITSU MOBILE COMMUNICATIONS LIMITED, Kawasaki-shi (JP)

(21) Appl. No.: 13/676,920

(22) Filed: Nov. 14, 2012

(30) Foreign Application Priority Data
Dec. 13, 2011 (JP) 2011-272803

(51) Int. Cl. H04W 40/02

(52) U.S. Cl. CPC H04W 40/02
USPC 370/315

(57) ABSTRACT

A wireless communication device includes a wireless communication control unit, a tethering request reception unit, a wireless communication system switch unit and a tethering control unit. The wireless communication control unit makes wireless communication with a predetermined communication network in wireless communication paths established by first wireless communication systems except a specific wireless communication system for packet communication among a plurality of mutually different wireless communication systems. The tethering request reception unit receives a tethering request of requesting to perform a tethering processing of relaying packet communication. When receiving a tethering request, the wireless communication system switch unit switches the first wireless communication systems for the established wireless communication paths to second wireless communication systems including the specific wireless communication system. When wireless communication paths by the switched second wireless communication systems are established, the tethering control unit performs the tethering processing in the established wireless communication paths.

### CROSS-REFERENCE TO RELATED APPLICATION

This application is based upon and claims the benefit of priority of the prior Japanese Patent Application No. 2011-272803, filed on Dec. 13, 2011, the entire contents of which are incorporated herein by reference.

### FIELD

The embodiment discussed herein is directed to a wireless communication device, a tethering control method, and a tethering control program.

### BACKGROUND

In recent years, there are widely used wireless communication devices such as portable terminals including Smartphone which mount a multi wireless function in a plurality of wireless communication systems. The wireless communication systems include LTE (Long Term Evolution), 3G (Third Generation), WiMAX (Trademark: Worldwide Interoperability for Microwave Access), WLAN (Wireless Local Area Network), and the like. Recently, a tethering function is paid attention as one communication technique applied to the wireless communication devices. The tethering function is a function by which a wireless communication device connected to an external device such as PC (Personal Computer), portable electronic device or portable game player relays packet communication between Internet and the external device.

With the tethering function, a plurality of external devices having no wireless function may be connected to Internet via a cellular network of the wireless communication device. As the number of external devices using the tethering function increases, traffics in wireless communication paths established between the wireless communication device and base stations rapidly increase and QoS (Quality of Service) of the wireless communication paths is difficult to maintain.

To the contrary, there is recently proposed a tethering control technique that limits traffics associated with the execution of the tethering function. With the tethering control technique, when receiving a tethering request of requesting to execute the tethering function, the wireless communication device switches normal APN (Access Point Name) indicating a connection destination for accessing Internet to other APN. Then, the wireless communication device charges a higher communication fee on an external device for accessing Internet via other switched APN than for accessing Internet via the normal APN. Thereby, a user of the external device may hesitate to execute the tethering function, thereby restricting the increase in traffics associated with the execution of the tethering function.
Patent Literature 1: Japanese Laid-open Patent Publication No. 2001-025066
Patent Literature 2: Japanese Laid-open Patent Publication No. 2002-368864
Patent Literature 3: Japanese Laid-open Patent Publication No. 2001-086563

However, the conventional technique has a problem that when the tethering function is executed, communication loads concentrate on one wireless communication path.

That is, when receiving a tethering request, the conventional technique switches normal APN belonging to a wireless communication path established in a specific wireless communication system to other APN. Thus, with the conventional technique, communication loads may concentrate on one wireless communication path established by the specific wireless communication system.

### SUMMARY

According to an aspect of an embodiment, a wireless communication device includes a wireless communication control unit that makes wireless communication with a predetermined communication network in wireless communication paths established by first wireless communication systems except a specific wireless communication system for packet communication among a plurality of mutually different wireless communication systems; a tethering request reception unit that receives a tethering request of requesting to perform a tethering processing of relaying packet communication between the communication network and an external device; a wireless communication system switch unit that, when the tethering request is received, switches the first wireless communication systems for the established wireless communication paths to second wireless communication systems including the specific wireless communication system; and a tethering control unit that, when wireless communication paths are established by the switched second wireless communication systems, performs the tethering processing in the established wireless communication paths.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an exemplary structure of a wireless communication system including a portable terminal according to an embodiment;

FIG. 2 is a diagram illustrating traffics in a wireless communication path established between a portable terminal and a base station for LTE;

FIG. 3 is a diagram illustrating an exemplary 3G tethering control method;

FIG. 4 is a diagram illustrating a hardware structure of the portable terminal according to the embodiment;

FIG. 5 is a diagram illustrating function blocks of the portable terminal according to the embodiment;

FIG. 6 is a diagram illustrating an exemplary switch target storage unit;

FIG. 7 is a diagram for explaining exemplary processings of a wireless communication system switch control unit when a tethering request is not received;

FIG. 8 is a diagram for explaining exemplary processings of the wireless communication system switch control unit when a tethering request is received;

FIG. 9 is a diagram for explaining processings of the wireless communication system switch control unit and a tethering control unit when a no-service state is detected;

FIG. 10 is a diagram for explaining other exemplary processings of the wireless communication system switch control unit when a no-service state is detected;

FIG. 11 is a flowchart illustrating a processing procedure by the portable terminal according to the embodiment; and

FIG. 12 is a flowchart illustrating a processing procedure by the portable terminal according to the embodiment when a no-service state is detected.

### DESCRIPTION OF EMBODIMENTS

Preferred embodiments of the present invention will be explained with reference to accompanying drawings. The disclosed technique is not limited to the following embodiment. For example, the following embodiment will be described by way of a portable terminal such as Smartphone as an exemplary wireless communication device, but is not limited thereto and any wireless communication device which mounts a multi wireless function and a tethering function may be employed.

Wireless communication devices such as Smartphone, which mount a multi wireless function in a plurality of wireless communication systems, are being widely used. The wireless communication systems include LTE (Long Term Evolution), 3G (third Generation), WiMAX (trademark: Worldwide Interoperability for Microwave Access), WLAN (Wireless Local Area Network), and the like. It is discussed that a function of relaying packet communication between external devices such as PC, portable electronic device and portable game player, and Internet is mounted on the wireless communication devices. The function is called tethering function.

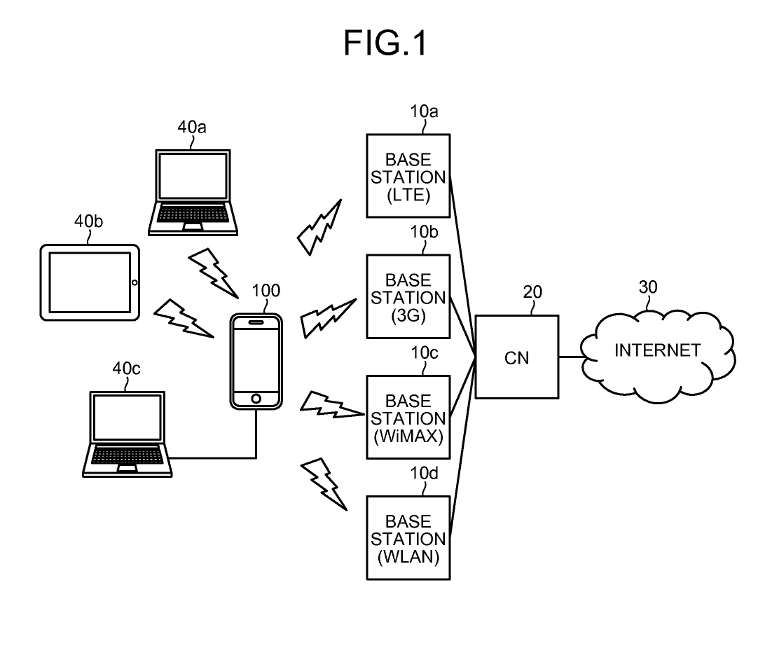

A wireless communication system including a portable terminal according to the present embodiment, which makes communication via the tethering function, will be described below. FIG. 1 is a diagram illustrating an exemplary structure of the wireless communication system including a portable terminal according to the present embodiment. The wireless communication system illustrated in FIG. 1 includes a portable terminal 100, base stations 10a to 10d, a core network (CN) 20, an Internet 30, and external devices 40a to 40c.

The portable terminal 100 uses a plurality of mutually different wireless communication systems LTE, 3G, WiMAX and WLAN to establish wireless communication paths with the base stations 10a to 10d, and makes wireless communication with Internet 30 via the base stations 10a to 10d and the CN 20. The portable terminal 100 is connected to the external devices 40a to 40c to relay packet communication between Internet 30 and the external devices 40a to 40c.

The base station 10a is a base station for LTE. The base station 10b is a base station for 3G. The base station 10c is a base station for WiMAX. The base station 10d is a base station for WLAN. The CN 20 is an upper network that relays between the base stations 10a to 10d and Internet 30. Internet 30 is a large-capacity wide area communication network. The external device 40a is wirelessly connected to the portable terminal 100 via WLAN, for example. The external device 40b is connected to the portable terminal 100 via Bluetooth (trademark), for example. The external device 40c is connected to the portable terminal 100 via USB (Universal Serial Bus) in a wired manner.

As described above, the portable terminal 100 according to the present embodiment performs a tethering processing of relaying packet communication between Internet 30 and the external devices 40a to 40c.

A problem associated with the tethering processing performed by the portable terminal 100 will be described below. In the wireless communication system illustrated in FIG. 1, as the number of external devices 40a to 40c using the tethering function increases, traffics in the wireless communication paths established between the portable terminal 100 and a base stations 10 rapidly increase, and thus QoS for the wireless communication paths is difficult to maintain.

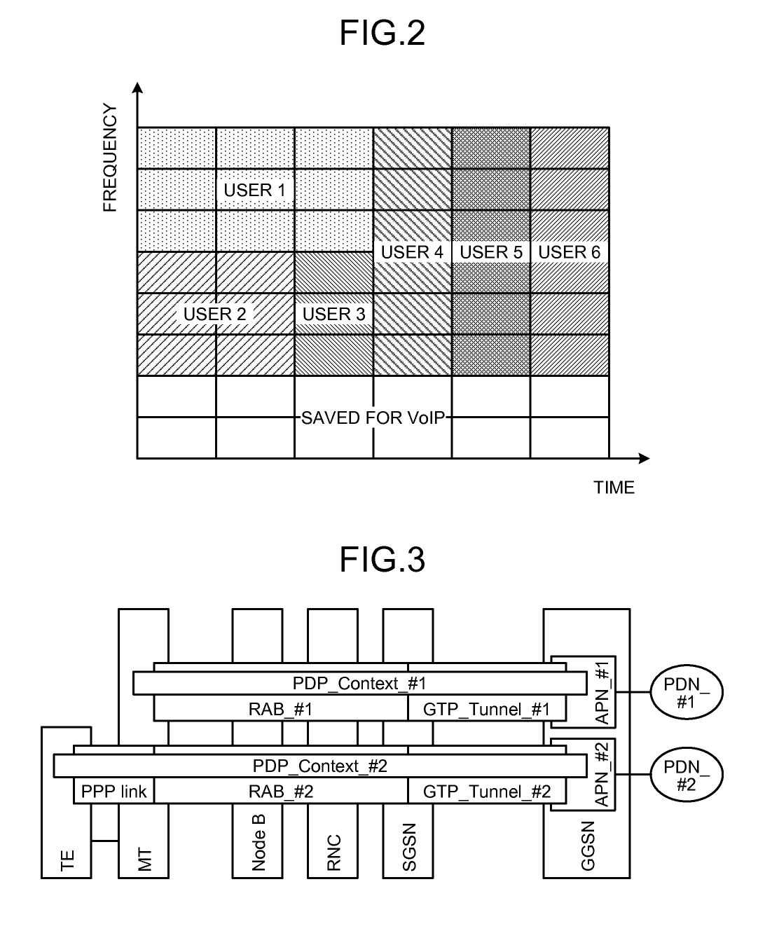

FIG. 2 is a diagram illustrating the traffics in the wireless communication path established between the portable terminal 100 and the base station 10a for LTE. In FIG. 2, time and frequency resources in the wireless communication path established between the portable terminal 100 and the base station 10a for LTE are illustrated. In FIG. 2, users 1 to 6 indicate the resources for packet communication assigned to the external devices using the tethering function.

With LTE, a predetermined frequency band is saved as a resource for VoIP (Voice over Internet Protocol) that transmits voice data. Thus, as illustrated with the users 1 to 6 in FIG. 2, as the number of external devices using the tethering function increases, the remaining resources other than the resource for VoIP decrease. Consequently, a new resource is not able to be assigned to an external device using the tethering function, and thus QoS for the wireless communication path established between the portable terminal 100 and the base station 10a for LTE may lower. The wireless communication paths established between the portable terminal 100 and other base stations 10b to 10d have the same problem. In order to avoid a reduction in QoS, a tethering control method that limits traffics associated with the execution of the tethering function may be applied to LTE and 3G.

The tethering control method will be described below before describing the tethering control method in the portable terminal 100 according to the present embodiment.

FIG. 3 is a diagram illustrating an exemplary tethering control method for 3G. In FIG. 3, MT (Mobile Terminal) corresponds to the portable terminal 100 illustrated in FIG. 1, TE (Terminal Equipment) corresponds to at least any one of external devices 40a, 40b, 40c illustrated in FIG. 1, and Node B corresponds to the base station 10b for 3G illustrated in FIG. 1. RNC (Radio Network Controller), SGSN (Serving GPRS (General Packet Radio Service) Support Node), and GGSN (Gateway GPRS Support Node) correspond to the CN 20 illustrated in FIG. 1.

As illustrated in FIG. 3, when not receiving a tethering request of requesting to execute the tethering function, MT in 3G transmits, to GGSN, a communication request command containing APN_{—}#1 as identification information for uniquely identifying GGSN at a connection destination. Thereby, a wireless access bearer RAB_{—}#1 is established between MT and SGSN, and a packet tunnel GTP_Tunnel_{—}#1 is established between SSGN and GGSN. The wireless access bearer RAB_{—}#1 and the packet tunnel GTP_Tunnel_{—}#1 form a packet communication path called PDP (Packet Data Protocol) context PDP_Context#1, which is identified by APN_{—}#1. MT accesses a packet data network PDN_{—}#1 as a kind of Internet via the PDP context PDP_Context#1 identified by APN_{—}#1.

On the other hand, when receiving a tethering request, MT switches APN_{—}#1 indicating a connection destination for accessing the packet data network PDN_{—}#1 to other APN_{—}#2. That is, when receiving a tethering request, MT transmits a communication request command containing other APN_{—}#2 to GGSN. Thereby, a wireless access bearer RAB_{—}#2 is established between MT and SGSN and a packet tunnel GTP_Tunnel_{—}#2 is established between SSGN and GGSN. The wireless access bearer RAB_{—}#2 and the packet tunnel GTP_Tunnel_{—}#2 form PDP context PDP_Context#2 which is identified by APN_{—}#2, together with a link PPP link (Point-to-Point Protocol) link between TE and MT. Then, MT accesses the packet data network PDN_{—}#2 via the PDP context PDP #2 which is identified by switched APN #2. MT charges a higher communication fee on TE for accessing the packet data network PDN_{—}#2 via switched APN_{—}#2 than for accessing the same via APN_{—}#1. Thereby, the user of the external device hesitates to execute the tethering function.

A problem associated with the tethering control method illustrated in FIG. 3 will be described below. When receiving a tethering request, MT switches normal APN belonging to the wireless communication path established by 3G to other APN. Thus, communication loads may concentrate on one wireless communication path established by 3G (the wireless communication path containing PDP_Context #1 and PDP_Context#2).

According to the present embodiment, the wireless communication system is switched, instead of switching APN, thereby avoiding the problem that communication loads concentrate on one wireless communication path.

A tethering control method according to the present embodiment will be described below. The portable terminal 100 according to the present embodiment makes wireless communication with Internet 30 in the wireless communication paths established by LTE, 3G and WLAN other than WiMAX among the four wireless communication systems LTE, 3G, WiMAX and WLAN. When receiving a tethering request, the portable terminal 100 switches the wireless communication systems from LTE, 3G and WLAN to WiMAX and 3G. When wireless communication paths are established by the switched wireless communication systems, the portable terminal 100 performs the tethering processing in the established wireless communication paths.

In this way, with the tethering control method according to the present embodiment, the wireless communication system is switched when receiving a tethering request, and thus communication loads are able to be prevented from concentrating on one wireless communication path. Consequently, communication loads are able to be distributed even when the tethering function is executed.

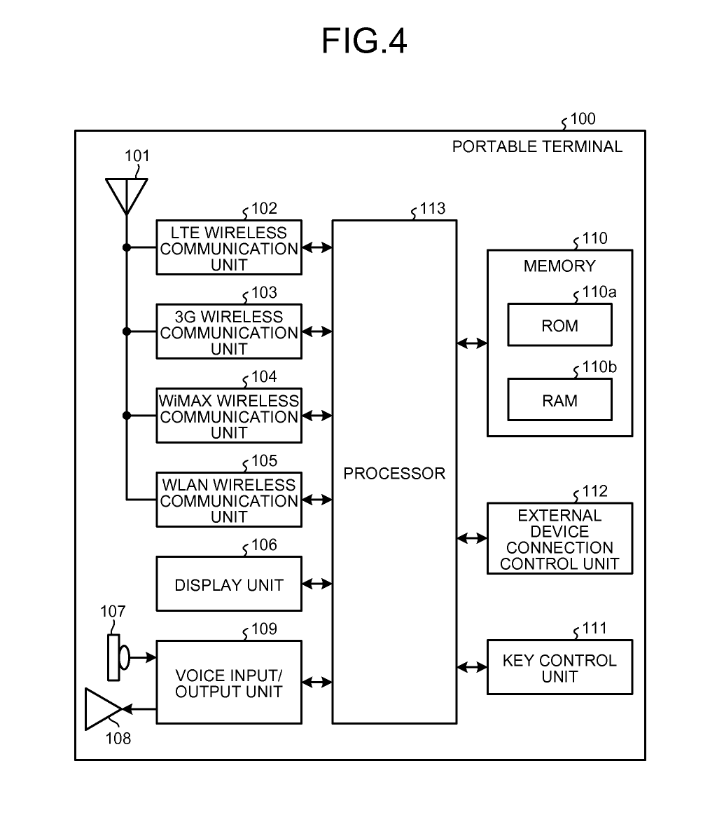

A hardware structure of the portable terminal 100 according to the present embodiment will be described below. FIG. 4 is a diagram illustrating the hardware structure of the portable terminal 100 according to the present embodiment. As illustrated in FIG. 4, the portable terminal 100 according to the present embodiment includes an antenna 101, a LTE wireless communication unit 102, a 3G wireless communication unit 103, a WiMAX wireless communication unit 104, a WLAN wireless communication unit 105, a display unit 106, a microphone 107, a speaker 108 and a voice input/output unit 109. The portable terminal 100 includes a memory 110, a key control unit 111, an external device connection control unit 112 and a processor 113.

The LTE wireless communication unit 102 wirelessly communicates various items of data such as voices and characters with the base station 10a for LTE via the antenna 101 according to the LTE communication standard. The 3G wireless communication unit 103 wirelessly communicates various items of data such as voices and characters with the base station 10b for 3G via the antenna 101 according to the third generation communication standard (3G). The WiMAX wireless communication unit 104 wirelessly communicates packet data such as characters with the base station 10c for WiMAX via the antenna 101 according to the WiMAX communication standard. The WLAN wireless communication unit 105 wirelessly communicates various items of data such as voices and characters with the base station 10d for WLAN via the antenna 101 according to the WLAN communication standard.

The display unit 106 is an output interface such as liquid crystal panel that displays various items of information such as characters and images. The key control unit 111 is an input interface that receives input operations of various items of information. The key control unit 111 may be integrated with the display unit 106 to be configured as a touch panel. The voice input/output unit 109 is an input/output interface that inputs voices via the microphone 107 and outputs voices via the speaker 108.

The external device connection control unit 112 is a communication interface that wirelessly connects at least any one of external devices 40a, 40b, 40c to the portable terminal 100 via WLAN or Bluetooth. The external device connection control unit 112 is a communication interface that connects an external device 40 to the portable terminal 100 via USB in a wired manner.

The memory 110 includes a ROM (Read Only Memory) 110a that stores data for executing various functions of the portable terminal 100, and a RAM (Random Access Memory) 110b that stores various programs for executing various functions.

The processor 113 is a calculation processing unit such as CPU (Central Processing Unit) that executes various programs stored in the ROM 110a or the RAM 110b. The processor 113 executes various programs stored in the ROM 110a or the RAM 110b thereby to control the LTE wireless communication unit 102, the 3G wireless communication unit 103, the WiMAX wireless communication unit 104 and the WLAN wireless communication unit 105. The processor 113 executes various programs stored in the ROM 110a or the RAM 110b thereby to control the display unit 106, the voice input/output unit 109 and the external device connection control unit 112. The programs executed by the processor 113 may be recorded in a distributable storage medium such as CD (Compact Disc)-ROM or memory medium, not only being stored in the ROM 110a or the RAM 110b, and may be read and executed from the storage medium. The programs may be stored in a server connected via a network such that the programs may operate on the server, and a service may be provided to the portable terminal 100 as a request source in response to a request from the portable terminal 100 connected via the network.

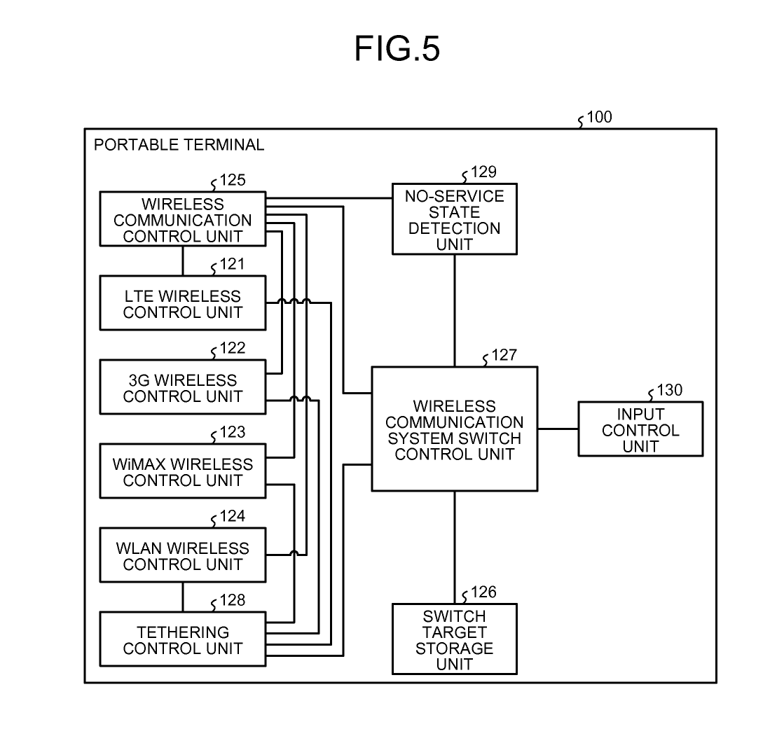

FIG. 5 is a diagram illustrating function blocks of the portable terminal 100 according to the present embodiment. As illustrated in FIG. 5, the portable terminal 100 includes a LTE wireless control unit 121 and a 3G wireless control unit 122 as the function blocks which the processor 113 reads and executes various programs from the ROM 110a or the RAM 110b to realize. The portable terminal 100 includes a WiMAX wireless control unit 123, a WLAN wireless control unit 124, a wireless communication control unit 125, a switch target storage unit 126, a wireless communication system switch control unit 127 and a tethering control unit 128 as the function blocks. The portable terminal 100 includes a no-service state detection unit 129 and an input control unit 130 as the function blocks.

The LTE wireless control unit 121 controls the LTE wireless communication unit 102 thereby to control wireless communication of various items of data such as voices and characters according to the LTE communication standard. Specifically, the LTE wireless control unit 121 controls the LTE wireless communication unit 102 thereby to establish a wireless communication path with the base station 10a for LTE and to exchange various items of data therewith.

The 3G wireless control unit 122 controls the 3G wireless communication unit 103 thereby to control wireless communication of various items of data such as voices and characters according to the third generation communication standard (3G). Specifically, the 3G wireless control unit 122 controls the 3G wireless communication unit 103 thereby to establish a wireless communication path with the base station 10b for 3G and to exchange various items of data therewith.

The WiMAX wireless control unit 123 controls the WiMAX wireless communication unit 104 thereby to control wireless communication of packet data such as characters according to the WiMAX communication standard. Specifically, the WiMAX wireless control unit 123 controls the WiMAX wireless communication unit 104 thereby to establish a wireless communication path with the base station 10c for WiMAX and to exchange packet data therewith.

The WLAN wireless control unit 124 controls the WLAN wireless communication unit 105 thereby to control wireless communication of various items of data such as voices and characters according to the WLAN communication standard. Specifically, the WLAN wireless control unit 124 controls the WLAN wireless communication unit 105 thereby to establish a wireless communication path with the base station 10d for WLAN and to exchange various items of data therewith.

The wireless communication control unit 125 makes wireless communication with Internet 30 in the wireless communication paths established by the wireless communication systems LTE, 3G and WLAN other than WiMAX for packet communication among the four wireless communication systems LTE, 3G, WiMAX and WLAN. Specifically, the wireless communication control unit 125 activates the LTE wireless control unit 121, the 3G wireless control unit 122 and the WLAN wireless control unit 124 which are set at Enable by the wireless communication system switch control unit 127, thereby to make wireless communication with Internet 30. The wireless communication control unit 125 stops controlling the WiMAX wireless control unit 123 set at Disable by the wireless communication system switch control unit 127. WiMAX is an exemplary specific wireless communication system that makes packet communication. Each of the wireless communication systems LTE, 3G and WLAN other than WiMAX among the four wireless communication systems is exemplary first wireless communication systems except the specific wireless communication system.

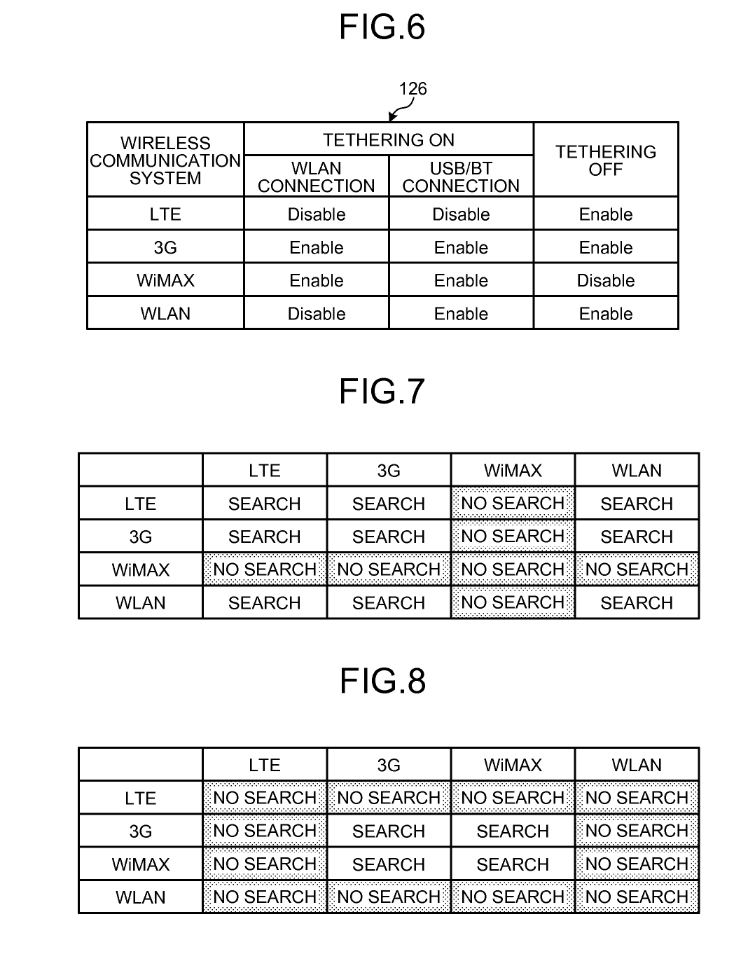

The switch target storage unit 126 stores information on the wireless communication systems to be switched by the wireless communication system switch control unit 127 which receives a tethering request. FIG. 6 is a diagram illustrating the exemplary switch target storage unit 126.

As illustrated in FIG. 6, the switch target storage unit 126 stores the items of “wireless communication system”, “tethering ON” and “tethering OFF” in an associated manner. “Wireless communication system” indicates a type of a wireless communication system to be switched by the wireless communication system switch control unit 127.

“Tethering ON” indicates information on which wireless communication system is to be used when the wireless communication system switch control unit 127 receives a tethering request. When a wireless communication system is used, “Enable” is described, and otherwise, “Disable” is described. “Tethering ON” contains the items of “WLAN connection” and “USB/BT connection.” “WLAN connection” indicates an item when the wireless communication system switch control unit 127 receives a tethering request while the portable terminal 100 is being connected to an external device via WLAN. “USB/BT connection” indicates an item when the wireless communication system switch control unit 127 receives a tethering request while the portable terminal 100 is being connected to an external device via USB or Bluetooth.

“Tethering OFF” indicates information on which wireless communication system is to be used when the wireless communication system switch control unit 127 does not receive a tethering request. When a wireless communication system is used, “Enable” is described, and otherwise, “Disable” is described.

The example of FIG. 6 illustrates that when the wireless communication system switch control unit 127 receives a tethering request while the portable terminal 100 is being connected to an external device via WLAN, 3G and WiMAX are used and LTE and WLAN are not used. The example of FIG. 6 indicates that when the wireless communication system switch control unit 127 receives a tethering request while the portable terminal 100 is being connected to an external device via USB or Bluetooth, 3G, WiMAX and WLAN are used and LTE is not used. The example of FIG. 6 indicates that when the wireless communication system switch control unit 127 does not receive a tethering request, LTE, 3G and WLAN are used and WiMAX is not used. The communication standard WiMAX dedicated to packet communication is low in continuity of future service and is relatively narrow in service area. Thus, in the present embodiment, WiMAX is set as a wireless communication system dedicated to the tethering function. Thereby, according to the present embodiment, loads on the wireless communication paths established by other wireless communication systems such as LTE during the execution of the tethering function are able to be distributed into the wireless communication path established by WiMAX.

When receiving a tethering request via the key control unit 111 and the input control unit 130, the wireless communication system switch control unit 127 switches the wireless communication systems LTE, 3G and WLAN other than WiMAX to the wireless communication systems WiMAX and 3G. The wireless communication systems WiMAX and 3G are exemplary second wireless communication systems including the specific wireless communication system.

The wireless communication system switch processings by the wireless communication system switch control unit 127 will be specifically described below. The following description assumes that the portable terminal 100 is wirelessly connected to an external device via WLAN. When not receiving a tethering request, the wireless communication system switch control unit 127 transmits a setting request of setting LTE, 3G and WLAN at Enable to the wireless communication control unit 125 with reference to the switch target storage unit 126. The wireless communication system switch control unit 127 transmits a setting request of setting WiMAX at Disable to the wireless communication control unit 125 with reference to the switch target storage unit 126. The wireless communication system switch control unit 127 preferentially searches a wireless communication path with a higher communication speed among the wireless communication paths established by the wireless communication systems LTE, 3G and WLAN via the wireless communication control unit 125. For example, the wireless communication system switch control unit 127 makes cell search on the base station 10a for LTE, the base station 10b for 3G and the base station 10d for WLAN in this order, thereby searching the wireless communication paths by LTE, 3G and WLAN in this order.

On the other hand, when receiving a tethering request, the wireless communication system switch control unit 127 transmits a setting request of setting 3G and WiMAX at Enable to the wireless communication control unit 125 with reference to the switch target storage unit 126. The wireless communication system switch control unit 127 transmits a setting request of setting LTE and WLAN at Disable to the wireless communication control unit 125 with reference to the switch target storage unit 126. Thereby, the wireless communication system switch control unit 127 switches the wireless communication systems LTE, 3G and WLAN to the wireless communication systems 3G and WiMAX. When switching the wireless communication systems, the wireless communication system switch control unit 127 preferentially searches the wireless communication path established by the wireless communication system WiMAX out of 3G and WiMAX. For example, the wireless communication system switch control unit 127 makes cell search on the base station 10c for WiMAX and the base station 10b for 3G in this order, thereby searching the wireless communication paths by WiMAX and 3G in this order.

FIG. 7 is a diagram for explaining exemplary processings by the wireless communication system switch control unit 127 when it does not receive a tethering request. As illustrated in FIG. 7, when not receiving a tethering request, the wireless communication system switch control unit 127 stops searching the wireless communication path established by the wireless communication system WiMAX, and searches a total of nine wireless communication paths by LTE, 3G and WLAN in this order. Thereby, power consumption is reduced, which is necessary for searching the wireless communication path established by the wireless communication system WiMAX.

FIG. 8 is a diagram for explaining exemplary processings by the wireless communication system switch control unit 127 when it receives a tethering request. As illustrated in FIG. 8, when receiving a tethering request, the wireless communication system switch control unit 127 stops searching the wireless communication paths established by the wireless communication systems LTE and WLAN, and searches a total of four wireless communication paths by WiMAX and 3G in this order. Thereby, power consumption is reduced, which is necessary for searching the wireless communication paths established by the wireless communication systems LTE and WLAN.

When the no-service state detection unit 129 described later detects a no-service state, the wireless communication system switch control unit 127 preferentially searches the wireless communication path established by the wireless communication system 3G other than WiMAX among the switched wireless communication systems WiMAX and 3G.

When the wireless communication paths are established by the wireless communication systems WiMAX and 3G after the switching by the wireless communication system switch control unit 127, the tethering control unit 128 performs a tethering processing on the established wireless communication paths. Specifically, the tethering control unit 128 activates the WiMAX wireless control unit 123 and the 3G wireless control unit 122 set at Enable by the wireless communication system switch control unit 127 to make wireless communication with Internet 30. The tethering control unit 128 stops controlling the LTE wireless control unit 121 and the WLAN wireless control unit 124 set at Disable by the wireless communication system switch control unit 127. Further, the tethering control unit 128 is connected to an external device 40 via the external device connection control unit 112. Thereby, the tethering control unit 128 uses the wireless communication paths by the wireless communication systems WiMAX and 3G to relay packet communication between Internet 30 and the external device 40.

The no-service state detection unit 129 detects a no-service state in which the wireless communication paths are not able to be established in LTE, 3G, WiMAX and WLAN. Specifically, the no-service state detection unit 129 monitors transmission waves from the base stations 10a to 10d via the wireless communication control unit 125, and when it is not able to capture all the transmission waves from the base stations 10a to 10d, detects a no-service state.

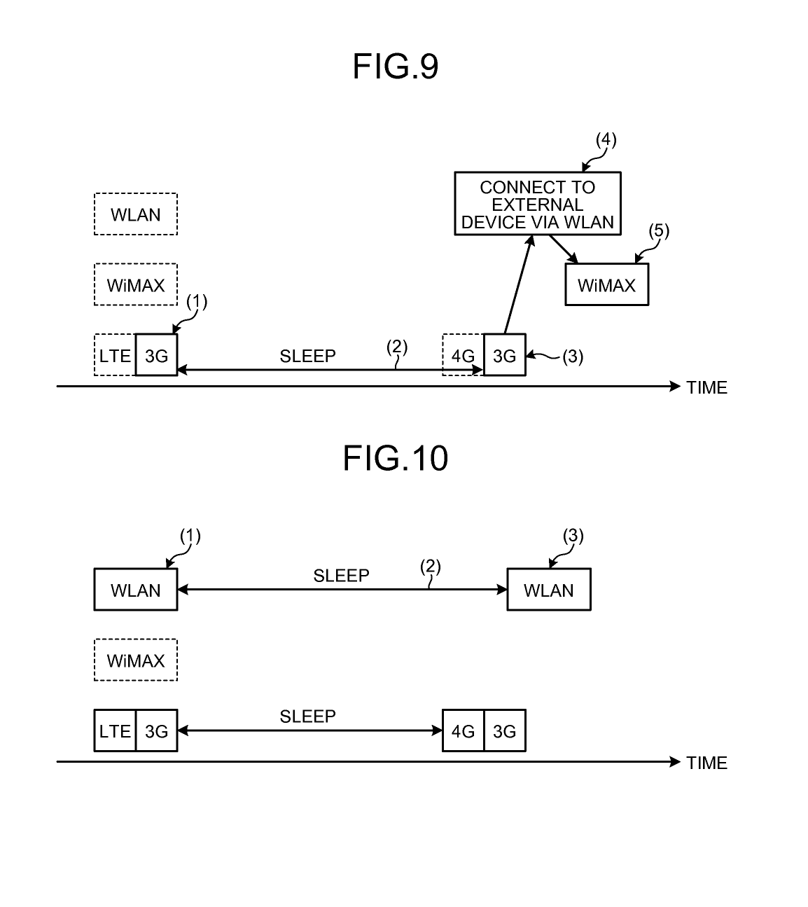

The processings by the wireless communication system switch control unit 127 and the tethering control unit 128 when a no-service state is detected will be specifically described below. FIG. 9 is a diagram for explaining the processings by the wireless communication system switch control unit 127 and the tethering control unit 128 when a no-service state is detected. FIG. 9 indicates a situation in which the wireless communication system switch control unit 127 having received a tethering request completes the switching of the wireless communication systems WiMAX and 3G and then a no-service state is detected by the no-service state detection unit 129.

As illustrated in FIG. 9, the wireless communication system switch control unit 127 preferentially searches the wireless communication path established by 3G over the wireless communication path established by WiMAX when a no-service state is detected (see (1)). When having not been able to capture the wireless communication path established by 3G, the wireless communication system switch control unit 127 enters a sleep state in which the searching of the wireless communication path is stopped for a predetermined time (see (2)). When returning from the sleep state, the wireless communication system switch control unit 127 searches the wireless communication path established by 3G again (see (3)). When the wireless communication path established by 3G is searched by the wireless communication system switch control unit 127, the tethering control unit 128 is connected to an external device via WLAN to restart the tethering processing (see (4)). When the tethering control unit 128 finishes connecting to the external device, the wireless communication system switch control unit 127 transmits a setting request of setting WiMAX at Enable to the wireless communication control unit 125 and searches the wireless communication path established by WiMAX (see (5)). Thereafter, the wireless communication system switch control unit 127 searches the wireless communication paths by WiMAX and 3G in this order.

In this way, when a no-service state is detected, the wireless communication system switch control unit 127 preferentially searches the wireless communication path established by 3G out of WiMAX and 3G. When the searched wireless communication path is established, the tethering control unit 128 is connected to the external device 40 to restart the tethering processing. Then, when having completed the connection to the external device 40, the wireless communication system switch control unit 127 searches the wireless communication path established by WiMAX. Thereby, the portable terminal 100 in the no-service state is able to rapidly recover the wireless communication of voice data by use of the wireless communication path established by 3G, and then is able to appropriately recover the packet communication by use of the wireless communication path established by WiMAX.

FIG. 10 is a diagram for explaining other exemplary processings by the wireless communication system switch control unit 127 when a no-service state is detected. FIG. 10 indicates a situation in which after the wireless communication system switch control unit 127 having not received a tethering request finishes searching the wireless communication paths by LTE, 3G and WLAN, the no-service state detection unit 129 detects a no-service state.

As illustrated in FIG. 10, when a no-service state is detected, the wireless communication system switch control unit 127 searches the wireless communication paths established by LTE, 3G and WLAN (see (1)). When having not been able to capture the wireless communication paths established by LTE, 3G and WLAN, the wireless communication system switch control unit 127 enters the sleep state (see (2)). When returning from the sleep state, the wireless communication system switch control unit 127 searches the wireless communication paths established by LTE, 3G and WLAN again (see (3)). In this way, when a no-service state is detected, the wireless communication system switch control unit 127 excludes the wireless communication path established by WiMAX to be searched, thereby reducing unwanted power consumption for searching the wireless communication path established by WiMAX.

Turning to FIG. 5, the input control unit 130 receives the input operations from the key control unit 111 and the input operations from the display unit 106. The input control unit 130 receives a tethering request of requesting to perform the tethering processing, for example.

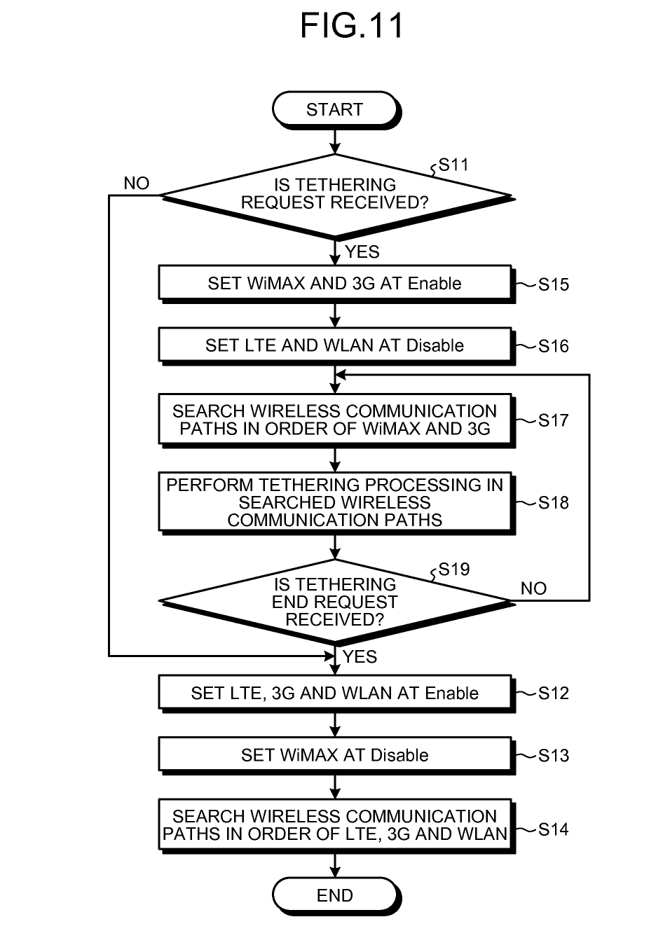

A processing procedure of the portable terminal 100 according to the present embodiment will be described below. FIG. 11 is a flowchart illustrating the processing procedure of the portable terminal 100 according to the present embodiment.

As illustrated in FIG. 11, when having not received a tethering request (Step S11; No), the portable terminal 100 sets LTE, 3G and WLAN at Enable (Step S12), and sets WiMAX at Disable (Step S13). The portable terminal 100 makes cell search on the base station 10a for LTE, the base station 10b for 3G and the base station 10d for WLAN in this order thereby to search the wireless communication paths by LTE, 3G and WLAN in this order (Step S14).

On the other hand, when having received a tethering request (Step S11; Yes), the portable terminal 100 sets WiMAX and 3G at Enable (Step S15), and sets LTE and WLAN at Disable (Step S16). Thereby, the portable terminal 100 switches the wireless communication systems LTE, 3G and WLAN to the wireless communication systems WiMAX and 3G. The portable terminal 100 searches the wireless communication paths by WiMAX and 3G in this order (Step S17). The portable terminal 100 performs the tethering processing in the searched wireless communication paths (Step S18).

While performing the tethering processing, the portable terminal 100 determines whether it has received a tethering end request of ending the tethering processing (Step S19). When having not received a tethering end request (Step S19; No), the portable terminal 100 returns to the processing in step S17. On the other hand, when having received a tethering end request (Step S19; Yes), the portable terminal 100 proceeds to the processing in step S12 to perform the processings (Steps S12 to S14) when it has not received a tethering request.

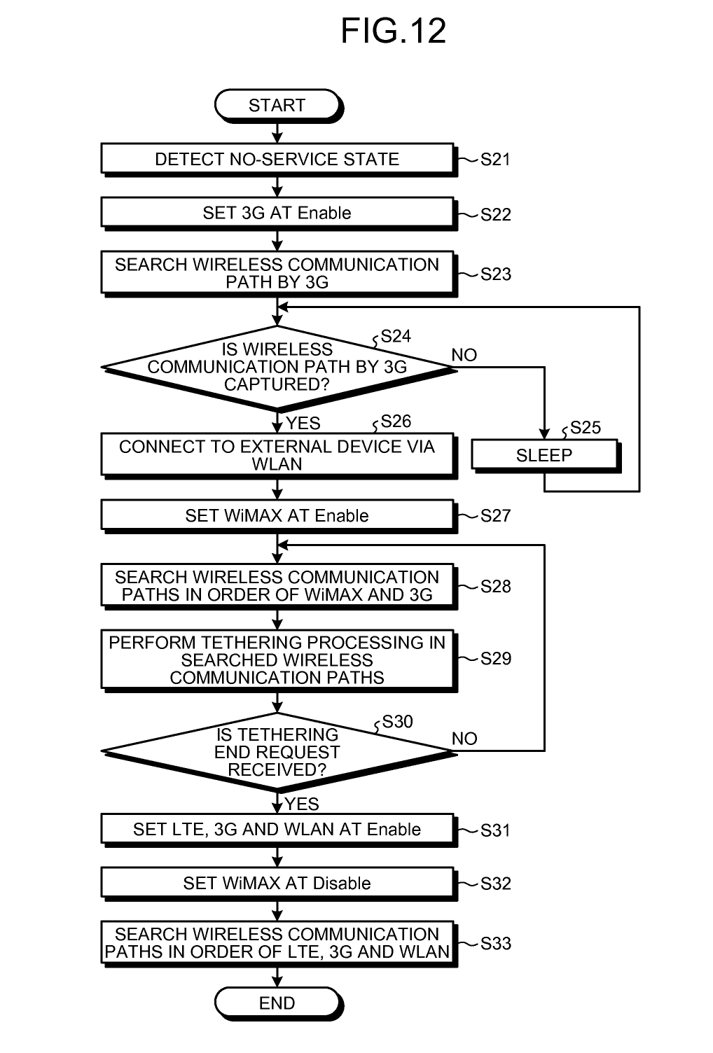

A processing procedure of the portable terminal 100 according to the present embodiment when a no-service state is detected will be described below. FIG. 12 is a flowchart illustrating the processing procedure of the portable terminal 100 according to the present embodiment when a no-service state is detected. FIG. 12 illustrates a processing procedure in a situation in which after the portable terminal 100 having received a tethering request finishes switching the wireless communication systems WiMAX and 3G, a no-service state is detected.

As illustrated in FIG. 12, when having detected a no-service state (Step S21), the portable terminal 100 sets 3G at Enable (Step S22), and preferentially searches the wireless communication path established by 3G (Step S23). When having not been able to capture the wireless communication path established by 3G (Step S24; No), the portable terminal 100 enters the sleep state in which the searching of the wireless communication path is stopped for a predetermined time (Step S25), and returns to the processing in step S24.

On the other hand, when the wireless communication path established by 3G is searched (Step S24; Yes), the portable terminal 100 is connected to an external device via WLAN to restart the tethering processing (Step S26). When having finished connecting to the external device, the portable terminal 100 sets WiMAX at Enable, and starts searching the wireless communication path established by WiMAX (Step S27). Thereafter, the portable terminal 100 searches the wireless communication paths by WiMAX and 3G in this order (Step S28). Then, the portable terminal 100 performs the tethering processing in the searched wireless communication paths (Step S29).

While performing the tethering processing, the portable terminal 100 determines whether it has received a tethering end request (Step S30). When having not received a tethering end request (Step S30; No), the portable terminal 100 returns to the processing in step S28.

On the other hand, when having received a tethering end request (Step S30; Yes), the portable terminal 100 sets LTE, 3G and WLAN at Enable (Step S31), and sets WiMAX at Disable (Step S32). Then, the portable terminal 100 makes cell search on the base station 10a for LTE, the base station 10b for 3G and the base station 10d for WLAN in this order, thereby to search the wireless communication paths by LTE, 3G and WLAN in this order (Step S33).

As described above, when having received a tethering request, the portable terminal 100 according to the present embodiment switches the wireless communication systems from LTE, 3G and WLAN to WiMAX and 3G, thereby performing the tethering processing in the wireless communication paths established by the switched wireless communication systems. Therefore, the portable terminal 100 according to the present embodiment is able to prevent communication loads from concentrating on one wireless communication path established by a specific wireless communication system. Consequently, the portable terminal 100 according to the present embodiment is able to distribute communication loads even when the tethering function is performed. The portable terminal 100 according to the present embodiment is able to eliminate the need of searching the wireless communication paths established by the wireless communication systems LTE and WLAN, thereby reducing power consumption.

When switching the wireless communication systems from LTE, 3G and WLAN to WiMAX and 3G, the portable terminal 100 according to the present embodiment preferentially searches the wireless communication path established by WiMAX. Thus, while the portable terminal 100 according to the present embodiment is executing the tethering function, communication loads concentrate on the wireless communication path established by WiMAX and communication loads in the wireless communication paths established by other wireless communication systems are able to be reduced.

When having not received a tethering request, the portable terminal 100 according to the present embodiment preferentially searches a wireless communication path having a higher communication speed among the wireless communication paths established by LTE, 3G and WLAN. Thus, during normal wireless communication when the tethering function is not performed, the portable terminal 100 according to the present embodiment is able to preferentially distribute communication loads to a wireless communication path having a higher communication speed, thereby efficiently distributing the communication loads.

The first embodiment has been described mainly by way of the wireless communication device, but is not limited thereto and is able to realize the same function as the above embodiment by executing a previously-prepared tethering control program in a computer. That is, the tethering control program causes the wireless communication device to perform the procedure of making wireless communication with a predetermined communication network in the wireless communication paths established by the first wireless communication systems other than the packet-dedicated communication system only for packet communication among the mutually different wireless communication systems. The tethering control program causes the wireless communication device to perform the procedure of receiving a tethering request of requesting to perform the tethering processing of relaying packet communication between the communication network and an external device. The tethering control program causes the wireless communication device to perform the procedure of, when receiving a tethering request, switching the first wireless communication systems for the established wireless communication paths to the second wireless communication systems including the packet-dedicated communication system. The tethering control program causes the wireless communication device to perform the procedure of, when the wireless communication paths by the switched second wireless communication systems are established, performing the tethering processing in the established wireless communication paths. The tethering control program may be distributed to a computer via a communication network such as Internet. The tethering control program may be recorded in a memory provided in a computer, a hard disk, or other computer readable storage medium, and may be read and executed from the storage medium by the computer.

One aspect of the wireless communication device disclosed in the present invention is able to obtain an effect of distributing communication loads when the tethering function is executed.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A wireless communication device comprising:
a wireless communication control unit that makes wireless communication with a predetermined communication network in wireless communication paths established by first wireless communication systems except a specific wireless communication system for packet communication among a plurality of mutually different wireless communication systems;
a tethering request reception unit that receives a tethering request of requesting to perform a tethering processing of relaying packet communication between the communication network and an external device;
a wireless communication system switch unit that, when the tethering request is received, switches the first wireless communication systems for the established wireless communication paths to second wireless communication systems including the specific wireless communication system; and
a tethering control unit that, when wireless communication paths are established by the switched second wireless communication systems, performs the tethering processing in the established wireless communication paths.

2. The wireless communication device according to claim 1, wherein when switching the first wireless communication systems to the second wireless communication systems, the wireless communication system switch unit preferentially searches a wireless communication path established by the specific wireless communication system among the wireless communication paths established by the second wireless communication systems.

3. The wireless communication device according to claim 1, wherein when not receiving the tethering request, the wireless communication system switch unit preferentially searches a wireless communication path having a higher communication speed among the wireless communication paths established by the first wireless communication systems.

4. The wireless communication device according to claim 1, further comprising
a no-service state detection unit that detects a no-service state in which wireless communication paths are not able to be established by the plurality of wireless communication systems, wherein
when a no-service state is detected by the no-service state detection unit, the wireless communication system switch unit preferentially searches the wireless communication paths established by the wireless communication systems other than the specific wireless communication system among the second wireless communication systems, and
when wireless communication paths are established by the wireless communication systems searched by the wireless communication system switch unit, the tethering control unit restarts the tethering processing by connecting to the external device.

5. The wireless communication device according to claim 4, wherein when the tethering control unit finishes connecting to the external device, the wireless communication system switch unit searches a wireless communication path established by the specific wireless communication system.

6. A tethering control method comprising:
making wireless communication with a predetermined communication network in wireless communication paths established by first wireless communication systems except a packet-dedicated communication system only for packet communication among a plurality of mutually different wireless communication systems;
receiving a tethering request of requesting to perform a tethering processing of relaying packet communication between the communication network and an external device;
when receiving the tethering request, switching the first wireless communication systems for the established wireless communication paths to second wireless communication systems including the packet-dedicated wireless communication system; and
when wireless communication paths by the switched second wireless communication systems are established, performing the tethering processing in the established wireless communication paths.

7. A computer readable recording medium having stored therein a tethering control program for causing a computer to execute a processing comprising:
making wireless communication with a predetermined communication network in wireless communication paths established by first wireless communication systems except a packet-dedicated communication system only for packet communication among a plurality of mutually different wireless communication systems;
receiving a tethering request of requesting to perform a tethering processing of relaying packet communication between the communication network and an external device;
when receiving the tethering request, switching the first wireless communication systems for the established wireless communication paths to second wireless communication systems including the packet-dedicated wireless communication system; and
when wireless communication paths by the switched second wireless communication systems are established, performing the tethering processing in the established wireless communication paths.
